(19) United States
(12) Patent Application Publication
(10) Pub. No.: US 2009/0215625 A1
(43) Pub. Date: Aug. 27, 2009

(54) Combinations of Herbicides and Safeners

(75) Inventors: J. Scott McElroy, Auburn, AL (US); Robert H. Walker, Auburn, AL (US)

Correspondence Address: ANDRUS, SCEALES, STARKE & SAWALL, LLP, 100 EAST WISCONSIN AVENUE, SUITE 1100, MILWAUKEE, WI, 53202, US

(73) Assignee: AUBURN UNIVERSITY, Auburn, AL (US)

(21) Appl. No.: 12/348,740

(22) Filed: Jan. 5, 2009

Related U.S. Application Data
(60) Provisional application No. 61/010,297, filed on Jan. 7, 2008.
(60) Provisional application No. 61/062,153, filed on Jan. 24, 2008.
(60) Provisional application No. 61/062,802, filed on Jan. 29, 2008.
(60) Provisional application No. 61/066,342, filed on Feb. 20, 2008.
(60) Provisional application No. 61/194,025, filed on Sep. 24, 2008.

(51) Int. Cl. A01N 25/32; A01P 21/00; A01P 13/00

(52) U.S. Cl. 504/107

(57) ABSTRACT

Disclosed are compositions that include combinations of herbicides and safeners. The disclosed compositions may include herbicidal compositions that comprise: (a) an effective amount of a carotenoid-biosynthesis inhibiting compound or a salt, ester, acid, or partial acid form thereof as an herbicide; and (b) an effective amount of an acetolactate synthase inhibiting compound or a salt, ester, acid, or partial acid form thereof as a safener.

### CROSS-REFERENCE TO RELATED APPLICATIONS

The present application claims the benefit of priority under 35 U.S.C. § 119(e) to U.S. provisional application Nos. 61/194,025 filed on Sep. 24, 2008; 61/066,342, filed on Feb. 20, 2008; 61/062,802, filed on Jan. 29, 2008; 61/062,153, filed on Jan. 24, 2008; and 61/010,297, filed on Jan. 7, 2008; the contents of which are incorporated herein by reference in their entireties.

### BACKGROUND

The present invention relates generally to combinations of herbicides and safeners.

A number of herbicidal active ingredients are known as inhibitors of enzymes that are part of the carotenoid biosynthesis pathway of plants. These enzymes include the enzyme 4-hydroxyphenylpyruvate dioxygenase (4-HPPD) and inhibitors of 4-HPPD are known in the art. (See, e.g., U.S. Pat. Nos. 6,069,115; 6,281,168; and 6,525,204). Assays for 4-HPPD activity and methods for identifying inhibitors of 4-HPPD also are known in the art. (See, e.g., U.S. Pat. No. 6,555,714.)

Many inhibitors of the carotenoid biosynthesis pathway are not always sufficiently well tolerated by plants, and accordingly, their use may be limited. They therefore cannot be employed for some plants, or may be employed only at such low application rates that the desired broad herbicidal activity against harmful plants is not ensured. To overcome these disadvantages, it is know in the art to apply herbicidal active compounds in combination with what is known as a safener or an antidote. (See, e.g., U.S. Pat. No. 6,511,940 and U.S. published application No. 2006030485).

Identifying a safener for a specific group of herbicides is difficult because the mechanisms by which a safener reduces the phytotoxic effect of herbicides to useful plants are not always known in detail. The fact that a compound acts as a safener in combination with a specific herbicide does not mean that the compound will act as a safener for other groups of herbicides. Therefore, further combinations of herbicides and safeners are desirable. It has now been found that certain compounds that inhibit acetolactate synthase (ALS) can be used as safeners for certain herbicides that inhibit carotenoid biosynthesis. Inhibitors of ALS are known in the art as are assays for ALS activity and methods of identifying inhibitors of acetolactate synthase. (See, e.g., U.S. Pat. Nos. RE36,175; 5,928,937; and 5,932,434.)

### SUMMARY

Disclosed are compositions that include combinations of herbicides and safeners. The disclosed compositions may include herbicidal compositions that comprise: (a) an herbicidally effective amount of a carotenoid-biosynthesis inhibiting compound or a salt, ester, acid, or partial acid form thereof; and (b) a safening effective amount of an acetolactate synthase inhibiting compound or a salt, ester, acid, or partial acid form thereof.

In some embodiments, the compositions may include an acetolactate synthase inhibiting compound which is classified in at least one of: Group B by Herbicide Resistance Action Committee (HRAC); and Class 2 by Weed Science Society of America (WSSA). Acetolactate synthase inhibiting compounds may include, but are not limited to flucarbazone, propoxycarbazone, thiencarbazone, amidosulfuron, azimsulfuron, bensulfuron-methyl, chlorimuron-ethyl, chlorsulfuron, cinosulfuron, cyclosulfamuron, ethametsulfuron-methyl, ethoxysulfuron, flazasulfuron, flupyrsulfinuron-methyl, foramsulfuron, halosulfinuron-methyl, imazosulfinuron, iodosulfinuron, metsulfinuron-methyl, nicosulfinuron, oxasulfinuron, primisulfinuron-methyl, prosulfinuron, pyrazosulfinuron-ethyl, rimsulfuron, sulfometuron-methyl, sulfosulfinuron, thifensulfinuron-methyl, triasulfinuron, tribenuron-methyl, trifloxysulfinuron, triflusulfinuron-methyl, tritosulfuron, Imazapic, imazamethabenz-methyl, imazamox, imazapyr, imazaquin, and imazethapyr, cloransulam-methyl, diclosulam, florasulam, flumetsulam, metosulam, bispyribac, pyribenzoxim, pyriftalid, pyrithiobac, pyriminobac-methyl, and salts, esters, acids, or partial acid forms thereof. Preferred compounds as safeners in the disclosed compositions include flucarbazone, propoxycarbazone, thiencarbazone, or salts, esters, acids, or partial acid forms thereof.

The acetolactate synthase inhibiting compound may be a triazolinone compound such as a sulfonylamino carbonyltriazolinone compound, or a salt, ester, acid, or partial acid forms thereof that functions as a safener. In some embodiments, the sulfonylamino carbonyltriazolinone compound is flucarbazone, propoxycarbazone, thiencarbazone, or analogs or derivatives thereof having acetolactate synthase inhibiting activity. In preferred embodiments, the compositions may include as a safener a sulfonylamino carbonyltriazolinone compound having a formula (I):

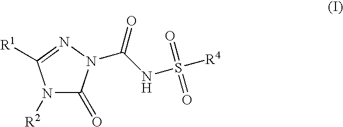

where:

R¹ is hydrogen; halogen (e.g., chloro, fluoro, bromo, or iodo); C₁₋₆ branched or straight-chain alkyl; C₃₋₆ cycloalkyl; C₂₋₆ alkenyl (e.g., [(E)-prop-1-enyl)]); C₂₋₆ alkynyl; —O—R³, —S—R³ (e.g., methylsulfanyl); or oxolan-3-yloxy;

R² is hydrogen; C₁₋₆ branched or straight-chain alkyl; C₃₋₆ cycloalkyl; C₂₋₆ alkenyl; C₂₋₆ alkynyl; amino, or —O—R³;

R³ is C₁₋₆ branched or straight-chain alkyl;

R⁴ is 5-membered or 6-membered aryl or heteroaryl; and

optionally, R⁴ is substituted with halogen; C₁₋₆ branched or straight-chain alkyl; C₃₋₆ cycloalkyl; C₂₋₆ alkenyl; C₂₋₆ alkynyl; C₁₋₆ alkoxy optionally substituted with one or more halogen substituents; carboxyl; or carboxyl ester having a formula —C(O)—O—R⁵, wherein R⁵ is C₁₋₆ branched or straight-chain alkyl. Preferably, R⁴ is phenyl or thienyl, where R⁴ optionally is substituted with halogen (e.g., chloro, fluoro, bromo, or iodo); C₁₋₆ branched or straight-chain alkyl; C₃₋₆ cycloalkyl; C₂₋₆ alkenyl; C₂₋₆ alkynyl; C₁₋₆ alkoxy optionally substituted with one or more halogen substituents (e.g., difluoromethoxy, trifluoromethoxy, methoxy, 1-difluoro, 2-difluoroethoxy); carboxyl; or carboxyl ester having a formula C(O)—O—R⁵, wherein R⁵ is C₁₋₆ alkyl.

In further embodiments, the compositions may include as a safener a sulfonylamino carbonyltriazolinone compound having a formula (II):

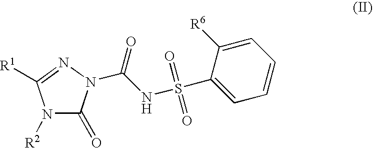

where:

R¹ is hydrogen; halogen (e.g., chloro, fluoro, bromo, or iodo); C₁₋₆ branched or straight-chain alkyl; C₃₋₆ cycloalkyl; C₂₋₆ alkenyl (e.g., [(E)-prop-1-enyl)]); C₂₋₆ alkynyl; —O—R³, —S—R³ (e.g., methylsulfanyl); or oxolan-3-yloxy;

R² is hydrogen; C₁₋₆ branched or straight-chain alkyl; C₃₋₆ cycloalkyl; C₂₋₆ alkenyl; C₂₋₆ alkynyl; amino, or O—R³;

R³ is C₁₋₆ branched or straight-chain alkyl; and

R⁶ is hydrogen, halogen (e.g., chloro, fluoro, bromo, or iodo); C₁₋₆ branched or straight-chain alkyl; C₃₋₆ cycloalkyl; C₂₋₆ alkenyl; C₂₋₆ alkynyl; C₁₋₆ alkoxy optionally substituted with one or more halogen substituents (e.g., difluoromethoxy, trifluoromethoxy, methoxy, 1-difluoro, 2-difluoroethoxy); carboxyl; or carboxyl ester having a formula —C(O)—O—R⁵, wherein R⁵ is C₁₋₆ alkyl.

In even further embodiments, the compositions may include as a safener a sulfonylamino carbonyltriazolinone compound having a formula (III):

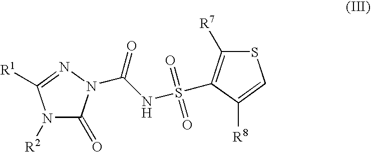

where:

R¹ is hydrogen; halogen (e.g., chloro, fluoro, bromo, or iodo); C₁₋₆ branched or straight-chain alkyl; C₃₋₆ cycloalkyl; C₂₋₆ alkenyl (e.g., [(E)-prop-1-enyl)]); C₂₋₆ alkynyl; —O—R³, —S—R³ (e.g., methylsulfanyl); or oxolan-3-yloxy;

R² is hydrogen; C₁₋₆ branched or straight-chain alkyl; C₃₋₆ cycloalkyl; C₂₋₆ alkenyl; C₂₋₆ alkynyl; amino, or —O—R³;

R³ is C₁₋₆ branched or straight-chain alkyl; and

R⁷ and R⁸ each independently are hydrogen, halogen (e.g., chloro, fluoro, bromo, or iodo); C₁₋₆ branched or straight-chain alkyl (e.g., methyl); C₃₋₆ cycloalkyl; C₂₋₆ alkenyl; C₂₋₆ alkynyl; C₁₋₆ alkoxy optionally substituted with one or more halogen substituents (e.g., difluoromethoxy, trifluoromethoxy, methoxy, 1-difluoro, 2-difluoroethoxy); carboxyl; or a carboxyl ester having a formula —C(O)—O—R⁵, wherein R⁵ is C₁₋₆ alkyl.

In some embodiments, the compositions include as an herbicide a carotenoid-biosynthesis inhibiting compound which is classified in at least one of: Group F1, F2, or F3 by the Herbicide Resistance Action Committee (HRAC); and Class 11, 12, 13 or 28 by the Weed Science Society of America (WSSA). Carotenoid-biosynthesis inhibiting compounds may include, but are not limited to mesotrione, sulcotrione, tembotrione, isoxachlortole, isoxaflutole, benzofenap, pyrazolynate, pyrazoxyfen, norflurazon, diflufenican, picolinafen, amitrole, clomazone, fluometuron, aclonifen, topramezone, benzobicyclon, beflubutamid, fluridone, fluorochloridone, flurtamone, and salts, esters, acids, or partial acid forms thereof (e.g., sodium salts thereof). Preferred compounds as herbicides in the disclosed compositions may include mesotrione, sulcotrione, tembotrione, topramezone, or salts, esters, acids, or partial acid forms thereof.

In some embodiments, the carotenoid-biosynthesis inhibiting compound is classified in at least one of Group F2 by Herbicide Resistance Action Committee (HRAC); and Class 28 by the Weed Science of America (WSSA). The carotenoid-biosynthesis inhibiting compound may be an inhibitor of 4-hydroxyphenyl-pyruvate-dioxygenase (4-HPPD). In further embodiments, the carotenoid-biosynthesis inhibiting compound may be a triketone compound, an isoxazole compound, or a pyrazole compound.

The compositions may include a carotenoid-biosynthesis inhibiting compound which is a triketone compound, or a salt, ester, acid, or partial acid form thereof that functions as an herbicide by inhibiting 4-hydroxyphenyl-pyruvate-dioxygenase (4-HPPD). In some embodiments, the triketone compound is selected from mesotrione, sulcotrione, tembotrione, or analogs or derivatives thereof having 4-hydroxyphenyl-pyruvate-dioxygenase (4-HPPD) inhibiting activity. In preferred embodiments, the compositions may include a triketone compound having a formula (IV):

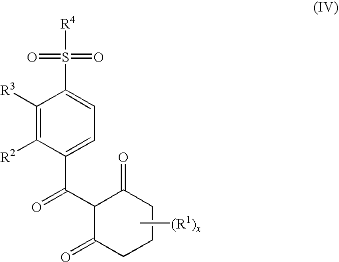

where

R¹ are each independently selected from hydrogen; halogen (e.g., chloro, fluoro, iodo, or bromo); C₁₋₆ branched or straight-chain alkyl; C₃₋₆ cycloalkyl; C₂₋₆ alkenyl; and C₂₋₆ alkynyl;

x is 0, 1, 2, 3, 4, 5, or 6;

R² is hydrogen; halogen (e.g., chloro, fluoro, iodo, or bromo); C₁₋₆ branched or straight-chain alkyl; C₃₋₆ cycloalkyl; C₂₋₆ alkenyl; C₂₋₆ alkynyl, or —N⁺(O)—O⁻;

R³ is hydrogen; halogen (e.g., chloro, fluoro, iodo, or bromo); C₁₋₆ branched or straight-chain alkyl; C₃₋₆ cycloalkyl; C₂₋₆ alkenyl; C₂₋₆ alkynyl; or alkyl-ether optionally substituted at one or more positions with halogen (e.g., —CH₂—O—CH₂—F₃); and

R⁴ is C₁₋₆ alkyl; and

the compound inhibits 4-HPPD activity.

The compositions may include a carotenoid-biosynthesis inhibiting compound which is an isoxazole compound (e.g., an isoxazole inhibitor of 4-HPPD). In some preferred embodiments, the isoxazole compound may include a compound selected from a group consisting of isoxachlortole and isoxaflutole. In further embodiments, the composition may include herbicidally effective amounts of salts, esters, acids, or partial acid forms of at least one of isoxachlortole and isoxaflutole.

The compositions may include a carotenoid-biosynthesis inhibiting compound which is a pyrazole compound (e.g., a pyrazole inhibitor of 4-HPPD). In some preferred embodiments, the pyrazole compound may include a compound selected from a group consisting of benzofenap, pyrazoxyfen, and pyrazolynate. In further embodiments, the composition may include herbicidally effective amounts of salts, esters, acids, or partial acid forms of at least one of benzofenap, pyrazoxyfen, and pyrazolynate.

The compositions may include other compounds which inhibit carotenoid-biosynthesis (e.g., other inhibitors of 4-HPPD). Other compounds may include topramezole, benzobicyclon, or salts, esters, acids, or partial acid forms thereof which inhibit 4-HPPD.

The disclosed herbicidal compositions may comprise: (a) an herbicidally effective amount of a carotenoid-biosynthesis inhibiting compound or a salt, ester, acid, or partial acid form thereof (e.g., an inhibitor of 4-HPPD as an herbicide); and (b) a safening effective amount of an acetolactate synthase inhibiting compound (i.e., an ALS inhibitor) or a salt, ester, acid, or partial acid form thereof. In some embodiments, the effective amount of (a) may be greater than the effective amount of (b). Preferred compositions may have a ratio of the effective amount of (a) to the effective amount of (b) which is at least about 2.5 to 1 (or at least about 5 to 1; or at least about 10 to 1, or at least about 20 to 1, or at least about 40 to 1; or at least about 80 to 1, or at least about 160 to 1, or at least about 320 to 1). Preferred ranges of ratios of the effective amount of (a) to the effective amount of (b) (i.e., “((a)_{high}-(a)_{low}):(b)”), in the compositions are (320-160):1, (320-80):1, (320-40):1, (320-20):1, (320-10):1, (320-5):1, (320-2.5):1, (160-80):1, (160-40):1, (160-20):1, (160-10):1, (160-5):1, (160-2.5):1, (80-40):1, (80-20):1, (80-10):1, (80-5):1, (80-2.5):1, (40-20):1, (40-10):1, (40-5):1, (40-2.5):1, (20-10):1, (20-5):1, (20-2.5):1, (10-2.5):1, (10-5):1, or (5-2.5):1.

Also disclosed are methods for selective control of weeds in and around plants. The methods may include applying the disclosed compositions directly to the plants, parts of plants, plant seeds, or the area under cultivation.

The disclosed methods for selective control of weeds in and around plants may include: (a) applying an herbicidally effective amount of one or more carotenoid-biosynthesis inhibiting herbicides (e.g., a 4-HPPD inhibiting herbicide); and (b) applying a safening effective amount of one or more acetolactate synthase inhibiting compounds or salts, esters, acids, or partial acid forms thereof as a safener before, after, or simultaneously with the application of the herbicide to the plants, parts of plants, plant seeds, or the area under cultivation. Suitable plants for the methods may include monocots (e.g., grasses such as zoysiagrass (Zoysia spp.), bermudagrass (Cynodon spp.), centipede grass (Eremochloa ophiuroides), St. Augustine grass (Stenatophrum secundatum), perennial ryegrass (Lolium perenne), fescue (Festuca/Lolium spp.), bluegrass (Poa spp.), oat (Atena sativa), wheat (Triticum spp.), barley (Hordeum vulgare), rye (Secale cereale), corn (Zea mays), sorghum (Sorghum spp.), and rice (Oryza spp.)).

Also disclosed are methods for protecting plants against phytotoxic side-effects of a carotenoid-biosynthesis inhibiting herbicide (e.g., a 4-HPPD inhibiting herbicide). The methods may include applying a safening effective amount of one or more acetolactate synthase inhibiting compounds or salts, esters, acids, or partial acid forms thereof as a safener before, after, or simultaneously with the application of the herbicide to the plants, parts of plants, plant seeds, or the area under cultivation. Suitable plants for the methods may include monocots (e.g., grasses such as zoysiagrass (Zoysia spp.), bermudagrass (Cynodon spp.), centipede grass (Eremochloa ophiuroides), St. Augustine grass (Stenatophrum secundatum), perennial ryegrass (Lolium perenne), fescue (Festuca/Lolium spp.), bluegrass (Poa spp.), oat (Atena sativa), wheat (Triticum spp.), barley (Hordeum vulgare), rye (Secale cereale), corn (Zea mays), sorghum (Sorghum spp.), and rice (Oryza spp.)).

In some embodiments of the disclosed methods, the amount of the applied herbicide (a) may be greater than the amount of the applied safener (b). In preferred embodiments, the ratio of the amount of the applied herbicide (a) to the amount of the applied safener (b) is at least about 2.5 to 1 (or at least about 5 to 1; or at least about 10 to 1, or at least about 20 to 1, or at least about 40 to 1; or at least about 80 to 1, or at least about 160 to 1, or at least about 320 to 1). Preferred ranges of ratios of the effective amount of (a) to the effective amount of (b) (i.e., “((a)_{high}-(a)_{low}):(b)”), are (320-160):1, (320-80):1, (320-40):1, (320-20):1, (320-10):1, (320-5):1, (320-2.5):1, (160-80):1, (160-40):1, (160-20):1, (160-10):1, (160-5):1, (160-2.5):1, (80-40):1, (80-20):1, (80-10):1, (80-5):1, (80-2.5):1, (40-20):1, (40-10):1, (40-5):1, (40-2.5):1, (20-10):1, (20-5):1, (20-2.5):1, (10-2.5):1, (10-5):1, or (5-2.5):1.

The herbicide may be applied at any suitable rate of application (e.g., within a range of about 0.01 kg ai/ha to about 1 kg ai/ha, and preferably within a range of about 0.02 to about 0.5 kg ai/ha). The safener may be applied at any suitable rate of application (e.g., within a range of about 0.01 kg ai/ha to about 0.2 kg ai/ha, and preferably within a range of about 0.01 to about 0.05 kg ai/ha).

### DETAILED DESCRIPTION

The disclosed subject matter is further described below.

Unless otherwise specified or indicated by context, the terms “a”, “an”, and “the” mean “one or more.”

As used herein, “about”, “approximately,” “substantially,” and “significantly” will be understood by persons of ordinary skill in the art and will vary to some extent on the context in which they are used. If there are uses of the term which are not clear to persons of ordinary skill in the art given the context in which it is used, “about” and “approximately” will mean plus or minus ≦10% of the particular term and “substantially” and “significantly” will mean plus or minus >10% of the particular term.

As used herein, the terms “include” and “including” have the same meaning as the terms “comprise” and “comprising.”

Classification of compounds as herbicides (i.e., the grouping of herbicides into classes and subclasses) is well-known in the art and includes classifications by HRAC (Herbicide Resistance Action Committee) and WSSA (the Weed Science Society of America) (see also, Retzinger and Mallory-Smith (1997) Weed Technology 11: 384-393, incorporated by reference in its entirety). Compounds useful as safeners in the compositions disclosed herein may include compounds which inhibit acetolactate synthase “ALS” (otherwise referred to as “acetohydroxyacid synthase” or “AHAS”) and which are classified in at least one of: Group B by Herbicide Resistance Action Committee (HRAC); and Class 2 by Weed Science Society of America (WSSA), which may include, but are not limited to sulfonylaminocarbonyl-triazolinones (e.g., flucarbazone, propoxycarbazone, and thiencarbazone), sulfonylureas (e.g., amidosulfuron, azimsulfuron, bensulfuron-methyl, chlorimuron-ethyl, chlorsulfuron, cinosulfuron, cyclosulfamuron, ethametsulfuron-methyl, ethoxysulfuron, flazasulfuron, flupyrsulfuron-methyl, foramsulfuron, halosulfuron-methyl, imazosulfuron, iodosulfuron, metsulfuron-methyl, nicosulfuron, oxasulfuron, primisulfuron-methyl, prosulfuron, pyrazosulfuron-ethyl, rimsulfuron, sulfometuron-methyl, sulfosulfuron, thifensulfuron-methyl, triasulfuron, tribenuron-methyl, trifloxysulfuron, triflusulfuron-methyl, and tritosulfuron), imidazolinones (e.g., Imazapic, imazamethabenz-methyl, imazamox, imazapyr, imazaquin, and imazethapyr), triazolopyrimidines (e.g., cloransulam-methyl, diclosulam, florasulam, flumetsulam, and metosulam), pyrimidinyl(thio)benzoates (e.g., bispyribac, pyribenzoxim, pyriftalid, pyrithiobac, and pyriminobac-methyl), and salts, esters, acids, or partial acid forms thereof (e.g., sodium salts thereof).

Compounds useful as herbicides in the compositions disclosed herein may include compounds which inhibit carotenoid biosynthesis and which are classified by the Herbicide Resistance Action Committee (HRAC) in at least one of: Group F1 (inhibition of carotenoid biosynthesis at the phytoene desaturase step PDS), F2 (inhibition of carotenoid biosynthesis at the 4-hydroxyphenyl-pyruvate-dioxygenase (4-HPPD) step), and F3 (inhibition of carotenoid biosynthesis at an unknown target); or are classified by the Weed Science Society of America (WSSA) in at least one of: Class 11 (triazoles), Class 12 (pyridazinones, pyridinecarboxamides, and others), Class 13 (isoxazolidinones, ureas, and diphenylethers) and Class 28 (triketones, isoxazoles, pyrazoles, and others). Suitable compounds as herbicides in the disclosed compositions may include, but are not limited to triketone compounds such as mesotrione, sulcotrione, and tembotrione; isoxazole compounds such as isoxachlortole and isoxaflutole; pyrazole compounds such as benzofenap, pyrazolynate, and pyrazoxyfen; pyridazoninone compounds such as norflurazon; pyridinecarboxamide compounds such as diflufenican and picolinafen; triazole compounds such as amitrole; isoxazolidinone compounds such as clomazone; urea compounds such as fluometuron; diphenylether compounds such as aclonifen; other compounds such as topramezone, benzobicyclon, beflubutamid, fluridone, fluorochloridone, and flurtamone; and salts, esters, acids, or partial acid forms thereof (e.g., sodium salts thereof).

In some embodiments, compound useful as safeners in the disclosed compositions may include flucarbazone, propoxycarbazone, thiencarbazone, or analogs or derivatives thereof having acetolactate synthase inhibiting activity (or salts, esters, acids, or partial acid forms thereof). Flucarbazone, propoxycarbazone, thiencarbazone, and analogs or derivatives thereof are known in the art. Referring to the PubChem Database provided by the National Center for Biotechnology Information (NCBI) of the National Institute of Health (NIH), flucarbazone, propoxycarbazone, thiencarbazone, analogs or derivatives may include, but are not limited to compounds referenced by PubChem Chemical Identification Numbers (CID Nos.) 3081367 (i.e., flucarbazone); 12056759 (i.e., propoxycarbazone sodium salt); 20056440 (i.e., 4-[(3-methoxy-4-methyl-5-oxo 1,2,4-triazole-1-carbonyl)sulfamoyl]-5-methylthiophene-3-carboxylic acid); 177355; 10893116; 10916615; 10938392; 11069288; 11200764; 11510058; 11528269; 11528276; 11715116; 11760881; 11947786; 11982601; 11982982; 12056759; 12056760; 15333068; 15333070; 15333078; 17869006; 18434446; 18534513; 18534514; 18534515; 18534516; 18534517; 18629735; 18629737; 18629741; 18629744; 18629751; 18629754; 18923837; 18923839; 18947669; 18947671; 19597199; 19739619; 19739620; 19739619; 22460430; 22460425; 18534516; 18629735; 18923839; 11715116; 22460427; 11760881; 18534515; 15333068; 18947671; 11078905; 11205152; 11205153; 11246693; 11640270; 11761263; 16070992; 18434701; 18737980; 18737998; 18737999; 18738000; 18738001; 18738002; 18738003; 18772483; 18772484; 18991252; 18991253; 18991254; 19876583; 20056440; 20588432; 23400837; 23400838; 23400839; 23672399; which entries are available at the National Center for Biotechnology Information website and are incorporated herein by reference in their entireties.

Flucarbazone has the IUPAC name 4,5-dihydro-3-methoxy-4-methyl-5-oxo-N-[2-(trifluoromethoxy)phenylsulfonyl]-1H-1,2,4-triazole-1-carboxamide. Flucarbazone has a formula:

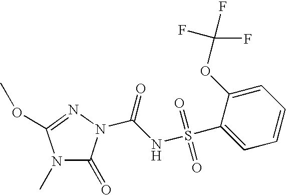

Propoxycarbazone has the IUPAC name methyl 2-[(4,5-dihydro-4-methyl-5-oxo-3-propoxy-1H-1,2,4-triazole-1-carboxamido)sulfonyl]benzoate. Propoxycarbazone has a formula:

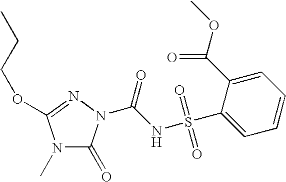

Thiencarbazone has the IUPAC name 4-[(4,5-dihydro-3-methoxy-4-methyl-5-oxo-1H-1,2,4-triazol-1-yl)carbonylsulfamoyl]-5-methylthiophene-3-carboxylic acid. Thiencarbazone has a formula:

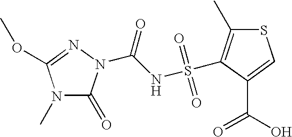

Thiencarbazone, analogs, and derivatives thereof also are described in U.S. Pat. No. 7,410,933, the content of which is incorporated herein by reference in its entirety.

In some embodiments, compounds utilized as safeners in the compositions disclosed herein may include flucarbazone, propoxycarbazone, thiencarbazone, or analogs or derivatives thereof. Preferably, analogs or derivatives of flucarbazone, propoxycarbazone, or thiencarbazone are sulfonylamino carbonyltriazolinone compounds having a formula (I), (II), or (III) as disclosed herein. Preferably, analogs or derivatives of flucarbazone, propoxycarbazone, or thiencarbazone have acetolactate synthase inhibiting activity and safen compositions comprising an herbicide having carotenoid biosynthesis inhibiting activity.

In some embodiments, compound useful as herbicides in the disclosed compositions may include mesotrione, tembotrione, sulcotrione, topramezone, analogs or derivatives thereof having carotenoid biosynthesis inhibiting activity (e.g., analogs or derivatives thereof having 4-HPPD inhibiting activity.) Suitable herbicides may include salts, esters, acids, or partial acid forms of mesotrione, tembotrione, sulcotrione, topramezone, or analogs or derivatives thereof having carotenoid biosynthesis inhibiting activity. Mesotrione, tembotrione, sulcotrione, analogs or derivatives thereof are known in the art and may include compounds referenced by PubChem Public Chemical Database Identification Numbers (CIDs) 175967 (i.e., mesotrione); 91760 (i.e., sulcotrione); 19937138; 18940330; 14749794; and 20066298; available at the National Center for Biotechnology Information website; and by CAS Registry Number 335104-84-2 (i.e., tembotrione), which entries are incorporated herein by reference in their entireties.

Mesotrione has the IUPAC name 2-(4-methylsulfonyl-2-nitrobenzoyl)cyclohexane-1,3-dione. Mesotrione has a formula:

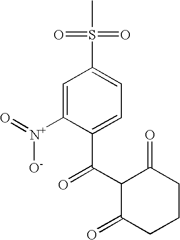

Tembotrione has the IUPAC name 2-{2-chloro-4-mesyl-3-[(2,2,2-trifluoroethoxy)methyl]benzoyl}cyclohexane-1,3-dione. Tembotrione has a formula:

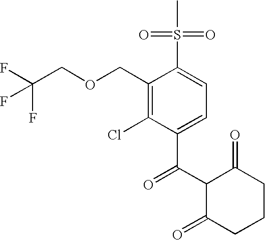

Sulcotrione has the IUPAC name 2-(2-chloro-4-methylsulfonylbenzoyl)cyclohexane-1,3-dione. Sulcotrione has a formula:

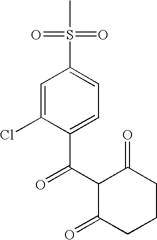

In some embodiments, mesotrione, tembotrione, sulcotrione, analogs or derivatives thereof may include a triketone compound having a formula (IV):

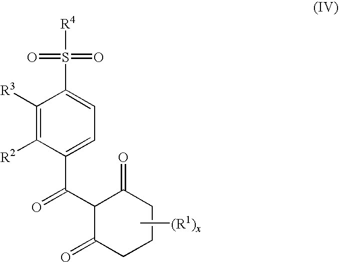

where:

R¹ are each independently selected from hydrogen; halogen (e.g., chloro, fluoro, iodo, or bromo); C₁₋₆ branched or straight-chain alkyl; C₃₋₆ cycloalkyl; C₂₋₆ alkenyl; and C₂₋₆ alkynyl;

x is 0, 1, 2, 3, 4, 5, or 6;

R² is hydrogen; halogen (e.g., chloro, fluoro, iodo, or bromo); C₁₋₆ branched or straight-chain alkyl; C₃₋₆ cycloalkyl; C₂₋₆ alkenyl; C₂₋₆ alkynyl, or —N⁺(O)—O⁻;

R³ is hydrogen; halogen (e.g., chloro, fluoro, iodo, or bromo); C₁₋₆ branched or straight-chain alkyl; C₃₋₆ cycloalkyl; C₂₋₆ alkenyl; C₂₋₆ alkynyl; or alkyl-ether optionally substituted at one or more positions with halogen (e.g., —CH₂—O—CH₂—F₃); and

R⁴ is C₁₋₆ alkyl; and

the compound inhibits 4-HPPD activity.

Topramezone is known in the art (CAS Registry Number 210631-68-8).

Topramezone has an IUPAC name [3-(4,5-dihydro-1,2-oxazol-3-yl)-4-mesyl-o-tolyl](5-hydroxy-1-methylpyrazol-4-yl)methanone. Topramezone has a formula:

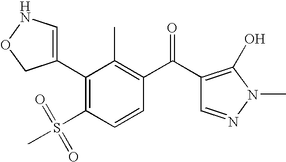

In some embodiments, topramezone, analogs or derivatives thereof may include a compound having a formula (V):

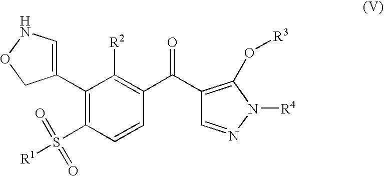

where:

R¹ is C₁₋₆ alkyl;

R² is hydrogen or C₁₋₆ alkyl;

R³ is hydrogen or C₁₋₆ alkyl;

R⁴ is hydrogen or C₁₋₆ alkyl; and

the compound inhibits 4-HPPD activity.

An “herbicidally effective amount” as used herein refers to an amount of one or more herbicides suitable for having an adverse effect on plant growth. A “safening effective amount” (i.e., “antidote-effective amount”) as used herein refers to an amount of one or more safeners suitable for at least partially counteracting the phytotoxic effect of an herbicide or herbicide mixture on a useful plant. In other words, a safener is understood as meaning a compound which compensates for, or reduces, the phytotoxic properties of an herbicide with regard to useful plants, without substantially reducing the herbicidal activity against harmful plants.

The compounds disclosed herein as safeners (i.e., antidotes) reduce or compensate for phytotoxic effects which may occur when using the herbicidally active compounds in and around plants without essentially adversely affecting the efficacy of these herbicidally active compounds against harmful plants (e.g., weeds). Thus, the field of application of conventional crop protection agents can be widened considerably and extended to, for example, plants such as grasses in which the use of the aforementioned herbicides has previously not been possible or only with limitations, that is to say at low dosages with a narrow spectrum of action.

The herbicidally active compounds (a) and the safener compounds (b) disclosed herein may be applied together (as a ready-mix or by a tank-mix method) or sequentially in any desired sequence. The weight ratio of herbicidally active compound (a) to safener compound (b) may vary within wide limits (e.g., 1:100 to 100:1, in particular from 1:10 to 10:1). In some embodiments, the effective amount of (a) may be greater than the effective amount of (b). Preferred compositions may have a ratio of the effective amount of (a) to the effective amount of (b) which is at least about 2.5 to 1 (or at least about 5 to 1; or at least about 10 to 1, or at least about 20 to 1, or at least about 40 to 1; or at least about 80 to 1, or at least about 160 to 1, or at least about 320 to 1). Preferred ranges of ratios of the effective amount of (a) to the effective amount of (b) (i.e., “((a)_{high}-(a)_{low}):(b)”), in the compositions are (320-160):1, (320-80):1, (320-40):1, (320-20):1, (320-10):1, (320-5):1, (320-2.5):1, (160-80):1, (160-40):1, (160-20):1, (160-10):1, (160-5):1, (160-2.5):1, (80-40):1, (80-20):1, (80-10):1, (80-5):1, (80-2.5):1, (40-20):1, (40-10):1, (40-5):1, (40-2.5):1, (20-10):1, (20-5):1, (20-2.5):1, (10-2.5):1, (10-5):1, or (5-2.5):1.

Depending on their properties, the safener compounds disclosed herein may be used for pre-treating the seed of the crop plant (seed dressing) or introduced into the seed furrows prior to sowing or used together with the herbicide before or after emergence of the plants. Pre-emergence treatment includes not only the treatment of the area under cultivation before sowing, but also the treatment of the sown soil which does not yet sustain vegetation. Preferably, the safener is applied together with the herbicide (e.g., as a tank-mix or ready-mix).

The application rates of the disclosed compositions may vary within a range of about 0.001 to 5 kg (preferably within a range of about 0.005 to 0.5 kg) of active compound per hectare. In some embodiments, the herbicide may be applied at a rate of application within a range of about 0.01 kg ai/ha to about 1 kg ai/ha, and preferably within a range of about 0.02 to about 0.5 kg ai/ha. In some embodiments, the safener may be applied at a rate of application within a range of about 0.01 kg ai/ha to about 0.2 kg ai/ha, and preferably within a range of about 0.01 to about 0.05 kg ai/ha.

The disclosed methods include methods of protect plants from phytotoxic side effects of herbicides such as inhibitors of carotenoid biosynthesis (including inhibitors of 4-HPPD). The methods may include applying a safener effective amount (i.e., an antidote-effective amount) of one or more compounds that inhibit acetolactate synthase before, after or simultaneously with the herbicide to the plants, plant seeds or the area under cultivation.

The safener compounds and their combinations with one or more of the afore-mentioned herbicidally active compounds may be formulated in various ways. Suitable possibilities of formulation are, for example, wettable powders (WP), emulsifiable concentrates (EC), water-soluble powders (SP), water-soluble concentrates (SL), concentrated emulsions (BW) such as oil-in-water and water-in-oil emulsions, sprayable solutions or emulsions, capsule suspensions (CS), oil- or water-based dispersions (SC), suspension concentrates, dusts (DP), oil-miscible solutions (OL), seed-dressing products, granules (GR) in the form of microgranules, spray granules, coated granules and absorption granules, granules for soil application or broadcasting, water-soluble granules (SG), water-dispersible granules (WG), ULV formulations, microcapsules and waxes. These individual formulation types are known in principle and are described, for example, in: Winnacker-Kuchler, “Chemische Technologie” [Chemical engineering], Volume 7, C. Hauser Verlag Munich, 4th Ed., 1986; Wade van Valkenburg, “Pesticide Formulations”, Marcel Dekker N.Y., 1973; K. Martens, “Spray Drying Handbook”, 3rd Ed. 1979, G. Goodwin Ltd. London (incorporated by reference herein in its entirety). The formulation auxiliaries which may be required, such as inert materials, surfactants, solvents and further additives are likewise known and described, for example, in: Watkins, “Handbook of Insecticide Dust Diluents and Carriers”, 2nd Ed., Darland Books, Caldwell N.J., H. v. Olphen, “Introduction to Clay Colloid Chemistry”; 2nd Ed., J. Wiley & Sons, N.Y.; C. Marsden, “Solvents Guide”; 2nd Ed., Interscience, N.Y. 1963; McCutcheon's “Detergents and Emulsifiers Annual”, MC Publ. Corp., Ridgewood N.J.; Sisley and Wood, “Encyclopedia of Surface Active Agents”, Chem. Publ. Co. Inc., N.Y. 1964; Schonfeldt, “Grenzflachenaktive Athylenoxidaddukte” [Surface-active ethylene oxide adducts], Wiss. Verlagsgesell., Stuttgart 1976; Winnacker-Kuchler, “Chemische Technologie”, Volume 7, C. Hauser Verlag Munich, 4th Ed. 1986 (incorporated by reference herein in their entirities). Based on these formulations, combinations with other crop protectants such as insecticides, acaricides, herbicides, fungicides, fertilizers and/or growth regulators may also be prepared, for example in the form of a ready-mix or a tank-mix.

Wettable powders are preparations which are uniformly dispersible in water and which, besides the active compound, additionally comprise ionic and/or nonionic surfactants (i.e., wetters, dispersants), for example polyoxethylated alkylphenols, polyoxethylated fatty alcohols, polyoxethylated fatty amines, fatty alcohol polyglycol ether sulfates, alkanesulfonates, alkylbenzenesulfonates, sodium lignosulfonate, sodium 2,2′-dinaphthylmethane-6,6′-disulfonate, sodium dibutylnaphthalene-sulfonate, or else sodium oleoylmethyltaurinate, in addition to a diluent or inert substance. To prepare the wettable powders, the herbicidally active compounds are ground finely, for example in customary apparatuses such as hammer mills, blower mills and air-jet mills, and simultaneously or subsequently mixed with the formulation auxiliaries.

Emulsifiable concentrates are prepared for example by dissolving the active compound in an organic solvent, for example butanol, cyclohexanone, DMF or else high-boiling hydrocarbons such as saturated or unsaturated aliphatic or alicyclic substances, aromatic substances or mixtures of these organic solvents with addition of one or more ionic and/or nonionic surfactants (i.e., emulsifiers). The following are examples of emulsifiers which may be used: calcium alkylarylsulfonates such as calcium dodecylbenzenesulfonate, or nonionic emulsifiers such as fatty acid polyglycol esters, alkylaryl polyglycol ethers, fatty alcohol polyglycol ethers, propylene oxide/ethylene oxide condensates, alkyl polyethers, sorbitan esters such as, for example, sorbitan fatty acid esters or polyoxyethylene sorbitan esters such as polyoxyethylene sorbitan fatty acid esters. Dusts are obtained in general by grinding the active compound with finely divided solid materials, for example talc, natural clays such as kaolin, bentonite and pyrophyllite, or diatomaceous earth.

Suspension concentrates may be water- or oil-based. They can be prepared for example by wet-milling by means of commercially available bead mills, if appropriate with addition of surfactants as, for example, have already been listed above in the case of the other formulation types. Emulsions, for example oil-in-water emulsions (EW), can be prepared for example by means of stirrers, colloid mills and/or static mixers using aqueous organic solvents and, if appropriate, surfactants as, for example, have already been listed above in the case of the other formulation types.

Granules can be produced either by spraying the active compound onto adsorptive granulated inert material or by applying active compound concentrates to the surface of carriers such as sand, kaolinite or of granulated inert material by means of binders, for example polyvinyl alcohol, sodium polyacrylate or else mineral oils. Suitable active compounds may also be granulated in the manner which is conventional for the production of fertilizer granules, if desired as a mixture with fertilizers.

Water-dispersible granules may be prepared by the customary methods such as spray-drying, fluidized-bed granulation, disk granulation, mixing by means of high-speed mixers, and extrusion without solid inert material. To prepare disk, fluidized-bed, extruder and spray granules, see, e.g., methods disclosed in “Spray-Drying Handbook” 3rd ed. 1979, G. Goodwin Ltd., London; J. E. Browning, “Agglomeration”, Chemical and Engineering 1967, pages 147 et seq.; “Perry's Chemical Engineer's Handbook”, 5th Ed., McGraw-Hill, New York 1973, pp. 8-57 (incorporated by reference herein in their entirities). For further details on the formulation of crop protection agents, see, e.g., G. C. Klingman, “Weed Control as a Science”, John Wiley and Sons, Inc., New York, 1961, pages 81-96 and J. D. Freyer, S. A. Evans, “Weed Control Handbook”, 5th Ed., Blackwell Scientific Publications, Oxford, 1968, pages 101-103 (incorporated by reference herein in their entirities). In addition, the active compound formulations mentioned comprise, if appropriate, the adhesives, wetters, dispersants, emulsifiers, penetrants, preservatives, antifreeze agents, solvents, fillers, carriers, colorants, antifoams, evaporation inhibitors, pH regulators and viscosity regulators which are conventional in each case.

### EXAMPLES

The following Examples are illustrative and are not intended to limit the scope of the claimed subject matter.

Summary of Safening Trials

Numerous trials were conducted to evaluate the potential for flucarbazone for reducing visual plant injury induced by carotenoid biosynthesis inhibiting herbicides. Research was conducted to evaluate applications of mesotrione and topramezone, two carotenoid biosynthesis inhibiting herbicides which induce plant tissue bleaching (whitening) of susceptible species. These herbicides were applied with and without flucarbazone and injury was visually rated on a scale of 0 to 100%, where 0 equals no injury and 100 equals complete green plant tissue bleaching. Three species, bermudagrass (Cynodon dacytlon), St. Augustinegrass (Stenotaphrum secumdatum), and zoysiagrass (Zoysia japonica), were selected for evaluation. These species are susceptible to injury from caortenoid-inhibiting herbicides.

Treatments were applied with a CO₂ pressurized spray system at a volume of 280 L ha⁻¹. A four nozzle spray boom utilizing 8002 XR flat fan nozzles (Spraying Systems, Inc, Wheaton, Ill.) on 25 cm spacing and a height of 25 cm was utilized. Spray pressure at the nozzle was 22 PSI and ground speed was 5 km/h. All treatments were applied with 0.25% v/v non-ionic surfactant (X-77 Non-Ionic Surfactant; Helena Chemical Company, Memphis, Tenn.).

Two runs of trials were conducted on all three species. Run one was initiated in early April when turfgrass species had reached 80 to 100% turfgrass greenup. Run two was initiated in early June.

Run One

Referring to Table 1, in general, mesotrione and topramezone injured all three turfgrass species more than comparative treatments of mesotrione plus flucarbazone or topramezone plus flucarbazone, respectively, at 13 days after treatment (DAT). Mesotrione plus flucarbazone at 0.029 kg ai/ha reduced zoysiagrass injury greater than lower flucarbazone rates 13 DAT. Topramezone plus flucarbazone at 0.028 kg ai/ha reduced bermudagrass injury greater than lower flucarbazone rates 13 DAT. These data indicate that flucarbazone at 0.028 kg ai/ha is potentially the optimum rate for safening bermudagrass and zoysiagrass. Topramezone plus flucarbazone at 0.029 kg ai/ha also injured bermudagrass and zoysiagrass less than combinations at lower rates at 20 DAT, further supporting the optimum rate. However, flucarbazone at 0.029 kg plus mesotrione or topramezone injured St. Augustinegrass greater than lower rate flucarbazone combinations; thus indicating that flucarbazone should be used at 0.007 and 0.015 kg ai/ha when applied in combination with mesotrione or topramezone.

Run Two

Referring to Table 2, two rates of mesotrione were evaluated in Run Two. Treatments were applied in early June. Normally what is observed with mesotrione applied to these species during this timing is earlier more rapid injury, that is sometimes more excessive. All flucarbazone plus mesotrione combination injured bermudagrass and St. Augustinegrass less than mesotrione alone at both rating dates. Variation was observed among flucarbazone rates, but injury was minimal (≦7%). Mesotrione at 0.18 kg ai/ha plus flucarbazone at 0.029 kg ai/ha injured zoysiagrass less than mesotrione at 0.18 kg ai/ha alone 7DAT; however, mesotrione at 0.18 kg ai/ha plus flucarbazone at lower rates did not significantly reduce injury greater than mesotrione alone at 0.18 kg ai/ha.

Broadleaf Weed Control

Referring to Table 3, while we have confirmed that flucarbazone reduces plant injury from carotenoid inhibiting herbicide, it was decided that this would be of no benefit if weed control was reduced as well. However, this was not the case. Flucarbazone at 0.007 or 0.029 kg ai/ha plus mesotrione at 0.28 kg ai/ha controlled Lamium amplexicaule, Stellaria media, and Geranium carolinianum (common broadleaf weeds) similar to mesotrione alone. Greater G. carolinianum control was observed with flucarbazone alone than combinations or mesotrione alone, indicating that mesotrione potentially antagonizes flucarbazone G. carolinianum control. This control reduction was alleviated with the addition of dicamba (a common broadleaf herbicide) applied below label rate at 0.28 kg ai/ha.

Safening Comparison of Propoxycarbazone and Flucarbazone

Propoxycarbazone is a similar herbicide to flucarbazone. Both are acetolactate synthase inhibiting herbicides in the sulfonylamino carbonyltriazolinone (also known as the triazolinone family) herbicide family. Table 4 refers to applications to comparisons of mesotrione plus flucarbazone or propoxycarbazone. Propoxycarbazone at all applied rates completely reduced the tissue injury (bleaching) to St. Augustinegrass turf at 15 days after treatment (DAT; maximum injury was observed at 15 DAT). Propoxycarbazone also decreased bleaching to bermudagrass turf; however, minor bleaching was still observed of approximately 10 to 12%. Mesotrione plus propoxycarbazone (0.42+0.177) reduced injury to bermudagrass turf equivalent to mesotrione plus flucarbazone (0.42+0.015); however, lower rates of propoxycarbazone combined with mesotrione were statistically greater than mesotrione plus flucarbazone.

Tembotrione Safening with Flucarbazone

Tembotrione is a carotenoid biosynthesis inhibiting herbicide that injures bermudagrass. Table 5 refers to research data evaluating the safening of flucarbazone when combined with tembotrione. Tembotrione applied at 0.023 to 0.092 kg/ha injured bermudagrass turf from 30 to 72%; with the greatest injury occurring at 0.092. All tembotrione plus flucarbazone treatments reduced bermudagrass injury when compared to the equivalent rates of tembotrione alone. Tembotrione (at 0.092 kg/ha) plus flucarbazone at 0.015 or 0.029 kg/ha injured bermudagrass 20; however, flucarbazone at 0.059 reduced bermudagrass injury greater to 8%. It is likely that higher rates of flucarbazone will be needed to provide adequate bermudagrass safening as higher rates of tembotrione are applied. A similar study was conducted on St. Augustine; however, no injury was observed from any tembotrione treatments indicating that St. Augustinegrass has inherent tolerance to tembotrione.

Large Crabgrass Control Comparison

Large crabgrass is a monocot weed normally controlled by mesotrione alone. A small study was conducted to determine if flucarbazone decreased mesotrione control of large crabgrass (Table 6). Treatments were applied to large crabgrass in the 1 to 2 tiller growth stage. This application timing is considered an early post-emergence application to relatively young large crabgrass. Research published in peer-reviewed scientific journals indicates that control of Digitaria spp. decreases with mesotrione alone as the size of the plant increases. From this study presented in Table 6, no control difference was observed between mesotrione alone and mesotrione plus flucarbazone when applied at the prescribed rates.

Topramazone Safening on Rice with Flucarbazone

Topramazone was applied to rice crops in the presence of flucarbazone. Safening was observed. (Table 7.)

In the foregoing description, certain terms have been used for brevity, clearness, and understanding. No unnecessary limitations are to be implied therefrom beyond the requirements of the prior art. The different composition and methods described herein may be used alone or in combination with other composition and methods. Various equivalents, alternatives, and modifications are possible.

TABLE 1
Bermudagrass, zoysiagrass, and St. Augustinegrass injury following applications of mesotrione, topramezone,
and flucarbazone treatments. All treatments were applied with 0.25% v/v non-ionic surfactants.¹

| | | Visual Turfgrass Injury ~13 DAT | | | Visual Turfgrass Injury ~20 DAT | | |
|---|---|---|---|---|---|---|---|
| | | | | St. | | | St. |
| | Rate | Bermudagrass | Zoysiagrass | Augustinegrass | Bermudagrass | Zoysiagrass² | Augustinegrass |
| Treatment | kg ai/ha | (JSM 08-4) | (JSM08-6) | (JSM 08-8) | (JSM 08-4) | (JSM08-6) | (JSM08-8) |
| Mesotrione | 0.25 | 12 | 30 | 5 | 7 | 0 | 12 |
| Flucarbazone | 0.007 | 0 | 0 | 0 | 0 | 0 | 2 |
| Flucarbazone | 0.015 | 0 | 0 | 0 | 0 | 0 | 3 |
| Flucarbazone | 0.029 | 0 | 0 | 0 | 0 | 0 | 12 |
| Mesotrione + | 0.25 + 0.007 | 0 | 20 | 0 | 0 | 0 | 0 |
| Flucarbazone | | | | | | | |
| Mesotrione + | 0.25 + 0.015 | 0 | 18 | 0 | 0 | 0 | 0 |
| Flucarbazone | | | | | | | |
| Mesotrione + | 0.25 + 0.029 | 0 | 8 | 0 | 0 | 0 | 10 |
| Flucarbazone | | | | | | | |
| Topramezone | 0.024 | 90 | 93 | 23 | 62 | 87 | 20 |
| Topramezone + | 0.024 + 0.007 | 63 | 58 | 3 | 38 | 45 | 0 |
| Flucarbazone | | | | | | | |
| Topramezone + | 0.024 + 0.015 | 53 | 50 | 3 | 25 | 38 | 0 |
| Flucarbazone | | | | | | | |
| Topramezone + | 0.024 + 0.029 | 42 | 43 | 0 | 23 | 23 | 13 |
| Flucarbazone | | | | | | | |
| Non-treated | | 0 | 0 | 0 | 0 | 0 | 0 |
| LSD (p = 0.05) | | 4 | 9 | 3 | 5 | 4 | 5 |

¹Visual turfgrass injury ratings are based on a 0 to 100% scale where 0 equals no plant damage and 100 equals complete disappearance of all green plant tissue.
²Zoysiagrass rated 13 and 22 days after treatment (DAT). Zoysiagrass treatments were applied to ‘Meyer’ zoysiagrass on Apr. 10, 2008. Bermudagrass treatments were applied to ‘Tifway’ bermudagrass on Apr. 3, 2008. St. Augustinegrass treatments were applied to ‘Palmetto’ St. Augustinegrass on Apr. 2, 2008.

TABLE 2
Additional bermudagrass, zoysiagrass, and St. Augustinegrass injury studies evaluating mesotrione, topramezone,
and flucarbazone treatments. All treatments were applied with 0.25% v/v non-ionic surfactants.¹

| | | Visual Turfgrass Injury 7 DAT | | | Visual Turfgrass Injury 21 DAT | | |
|---|---|---|---|---|---|---|---|
| | | | | St. | | | St. |
| | | Bermudagrass | Zoysiagrass | Augustinegrass | Bermudagrass | Zoysiagrass | Augustinegrass |
| | Rate | (JSM 08-14) | (JSM08-15) | (JSM08-14) | (JSM 08-14) | (JSM08-15) | (JSM08-14) |
| Treatment | kg ai/ha | % | | | | | |
| Mesotrione | 0.18 | 32 | 18 | 38 | 23 | 20 | 32 |
| Mesotrione | 0.28 | 35 | 22 | 40 | 27 | 23 | 33 |
| Flucarbazone | 0.007 | 0 | 0 | 0 | 0 | 0 | 0 |
| Flucarbazone | 0.015 | 0 | 2 | 0 | 0 | 0 | 0 |
| Flucarbazone | 0.029 | 0 | 0 | 2 | 0 | 0 | 0 |
| Mesotrione + | 0.18 + 0.007 | 2 | 12 | 3 | 0 | 0 | 0 |
| Flucarbazone | | | | | | | |
| Mesotrione + | 0.18 + 0.015 | 0 | 12 | 5 | 0 | 0 | 0 |
| Flucarbazone | | | | | | | |
| Mesotrione + | 0.18 + 0.028 | 2 | 7 | 0 | 0 | 0 | 0 |
| Flucarbazone | | | | | | | |
| Mesotrione + | 0.28 + 0.007 | 5 | 10 | 7 | 0 | 0 | 0 |
| Flucarbazone | | | | | | | |
| Mesotrione + | 0.28 + 0.015 | 5 | 13 | 2 | 0 | 0 | 0 |
| Flucarbazone | | | | | | | |
| Mesotrione + | 0.28 + 0.029 | 3 | 12 | 2 | 0 | 0 | 0 |
| Flucarbazone | | | | | | | |
| Non-treated | | 0 | 0 | 0 | 0 | 0 | 0 |
| LSD (p = 0.05) | | 5 | 10 | 5 | 2 | 3 | 3 |

¹Visual turfgrass injury ratings are based on a 0 to 100% scale where 0 equals no plant damage and 100 equals complete disappearance of all green plant tissue. Zoysiagrass treatments were applied to ‘Meyer’ zoysiagrass on Jun. 2, 2008. Bermudagrass treatments were applied to ‘Tifway’ bermudagrass on Jun. 2, 2008. St. Augustinegrass treatments were applied to ‘Palmetto’ St. Augustinegrass on Jun. 2, 2008.

TABLE 3
Control of common weed species with mesotrione, flucarbazone,
and dicamba alone and in combination (JSM 08-5).¹

| | | Weed Control 21 DAT | | |
|---|---|---|---|---|
| | | Lamium | Stellaria | Geranium |
| | Rate | amplexicaule | media | carolinianum |
| Treatments | kg ai/ha | % | | |
| Mesotrione | 0.28 | 100 | 100 | 20 |
| Flucarbazone | 0.007 | 3 | 35 | 62 |
| Flucarbazone | 0.029 | 10 | 62 | 55 |
| Mesotrione + | 0.28 + 0.007 | 100 | 100 | 27 |
| Flucarbazone | | | | |
| Mesotrione + | 0.28 + 0.029 | 83 | 93 | 30 |
| Flucarbazone | | | | |
| Dicamba | 0.28 | 10 | 65 | 73 |
| Mesotrione + | 0.28 + | 100 | 100 | 73 |
| Flucarbazone + | 0.007 + | | | |
| Dicamba | 0.28 | | | |
| Mesotrione + | 0.28 + | 100 | 98 | 62 |
| Flucarbazone + | 0.029 0.28 | | | |
| Dicamba | | | | |
| Non-Treated | | 0 | 0 | 0 |
| LSD (p = 0.05) | | 21 | 18 | 34 |

¹Treatments were evaluated on a 0 to 100% scale where 0 equals no plant injury and 100 equals complete plant death. Treatments were applied Apr. 3, 2008.

TABLE 4
Comparison of propoxycarbazone and flucarbazone
for safening of mesotrione when applied to
bermudagrass and St. Augustinegrass.¹

| | | Turfgrass Injury 15 DAT | |
|---|---|---|---|
| | Rate | Bermudagrass | St. Augustinegrass |
| Treatments | kg ai/ha | % | |
| Mesotrione | 0.42 | 28 | 35 |
| Flucarbazone | 0.015 | 0 | 0 |
| Propoxycarbazone | 0.044 | 0 | 0 |
| Propoxycarbazone | 0.088 | 0 | 0 |
| Propoxycarbazone | 0.177 | 0 | 0 |
| Mesotrione + | 0.42 + 0.015 | 3 | 0 |
| Flucarbazone | | | |
| Mesotrione + | 0.42 + 0.044 | 12 | 0 |
| Propoxycarbazone | | | |
| Mesotrione + | 0.42 + 0.088 | 12 | 0 |
| Propoxycarbazone | | | |
| Mesotrione + | 0.42 + 0.177 | 10 | 0 |
| Propoxycarbazone | | | |
| LSD (p = 0.05) | | 10 | 3 |

¹Treatments were evaluated on a 0 to 100% scale where 0 equals no plant injury and 100 equals complete plant death. Treatments were applied Apr. 3, 2008.

TABLE 5
Effect of combinations of flucarbazone plus tembotrione (carotenoid
biosynthesis inhibiting herbicide) on bermudagrass turf.¹

| | | Bermudagrass Injury | |
|---|---|---|---|
| | Rate | 13 DAT | 23 DAT |
| Treatments | kg ai/ha | % | |
| Tembotrione | 0.023 | 30 | 0 |
| Tembotrione | 0.046 | 50 | 0 |
| Tembotrione | 0.092 | 72 | 0 |
| Tembotrione + Flucarbazone | 0.023 + 0.015 | 0 | 0 |
| Tembotrione + Flucarbazone | 0.046 + 0.015 | 3 | 0 |
| Tembotrione + Flucarbazone | 0.092 + 0.015 | 20 | 0 |
| Tembotrione + Flucarbazone | 0.092 + 0.029 | 20 | 0 |
| Tembotrione + Flucarbazone | 0.092 + 0.059 | 8 | 0 |
| LSD (p = 0.05) | | 10 | NA |

¹Treatments were evaluated on a 0 to 100% scale where 0 equals no plant injury and 100 equals complete plant death. Primary injury observed was tissue whitening, with no plant necrosis. Treatments were applied Jul. 16, 2008. A similar study was also conducted on St. Augustinegrass, however neither tembotrione or flucarbazone induced injury to St. Augustinegrass at anytime.

TABLE 6
Large crabgrass control comparison of flucarbazone.¹

| | | Large Crabgrass Control | |
|---|---|---|---|
| | Rate | 21 DAT | 51 DAT |
| Treatments | kg ai/ha | % | |
| Flucarbazone | 0.009 | 17 | 0 |
| Mesotrione | 0.175 | 95 | 78 |
| Flucarbazone + Mesotrione | 0.009 + 0.175 | 93 | 70 |
| LSD (p = 0.05) | | 6 | 10 |

¹Treatments were evaluated on a 0 to 100% scale where 0 equals no plant injury and 100 equals complete plant death. Greater than 70% constitutes commercially acceptable control. Greater than 90% constitutes virtual elimination of all green plant tissue via plant necrosis. Treatments were applied May 19, 2008.

TABLE 7
Effect of combinations of flucarbazone plus topramazaone on rice.

| Crop Name | | | | | | | Rice | Rice |
|---|---|---|---|---|---|---|---|---|
| Rating Date | | | | | | | Dec. 05, 2008 | Dec. 09, 2008 |
| Rating Data Type | | | | | | | Injury | Injury |
| Rating Unit | | | | | | | % | % |
| Days After First/Last Applic. | | | | | | | 10/10 | 14/14 |
| Treatment Evaluation Interval | | | | | | | 10 Days | 14 Days |
| Trt | Treatment | Form | Form | Form | | Rate | | |
| No. | Name | Conc | Unit | Type | Rate | Unit | | |
| 1 | TOPRAMAZONE | 2.8 | LB/GAL | SC | 3 | fl oz/a | 50.0 | 60.0 |
| | (BAS 670) | | | | | | | |
| | NIS | | | SL | 0.25 | % v/v | | |
| 2 | TOPRAMAZONE | 2.8 | LB/GAL | SC | 3 | fl oz/a | 43.3 | 38.3 |
| | (BAS 670) | | | | | | | |
| | FLU | 70 | % W/W | WDG | 0.45 | oz/a | | |
| | NIS | | | SL | 0.25 | % v/v | | |
| 3 | TOPRAMAZONE | 2.8 | LB/GAL | SC | 1 | fl oz/a | 38.3 | 18.3 |
| | (BAS 670) | | | | | | | |
| | FLU | 70 | % W/W | WDG | 0.9 | oz/a | | |
| | NIS | | | SL | 0.25 | % v/v | | |
| 4 | TOPRAMAZONE | 2.8 | LB/GAL | SC | 1 | fl oz/a | 28.3 | 21.7 |
| | (BAS 670) | | | | | | | |
| | FLU | 70 | % W/W | WDG | 1.8 | oz/a | | |
| | NIS | | | SL | 0.25 | % v/v | | |

We claim:

1. An herbicidal composition comprising:
(a) an herbicidally effective amount of a carotenoid-biosynthesis inhibiting compound or a salt, ester, acid, or partial acid form thereof, wherein the carotenoid-biosynthesis inhibiting compound is an inhibitor of 4-hydroxyphenyl-pyruvate-dioxygenase (4-HPPD);
(b) a safening effective amount of an acetolactate synthase inhibiting compound or a salt, ester, acid, or partial acid form thereof.

2. The composition of claim 1, wherein the ratio of (a) to the ratio of (b) is greater than about 2.5:1.

3. The composition of claim 1, wherein the ratio of (a) to the ratio of (b) is greater than about 5:1.

4. The composition of claim 1, wherein the ratio of (a) to the ratio of (b) is greater than about 10:1.

5. The composition of claim 1, wherein the acetolactate synthase inhibiting compound is classified in Group B by Herbicide Resistance Action Committee (HRAC) and in Class 2 by Weed Science Society of America (WSSA).

6. The composition of claim 1, wherein the acetolactate synthase inhibiting compound is selected from a group consisting of flucarbazone, propoxycarbazone, amidosulfuron, azimsulfuron, bensulfuron-methyl, chlorimuron-ethyl, chlorsulfuron, cinosulfuron, cyclosulfamuron, ethametsulfuron-methyl, ethoxysulfuron, flazasulfuron, flupyrsulfuron-methyl, foramsulfuron, halosulfuron-methyl, imazosulfuron, iodosulfuron, metsulfuron-methyl, nicosulfuron, oxasulfuron, primisulfuron-methyl, prosulfuron, pyrazosulfuron-ethyl, rimsulfuron, sulfometuron-methyl, sulfosulfuron, thifensulfuron-methyl, triasulfuron, tribenuron-methyl, trifloxysulfuron, triflusulfuron-methyl, tritosulfuron, Imazapic, imazamethabenz-methyl, imazamox, imazapyr, imazaquin, and imazethapyr, cloransulam-methyl, diclosulam, florasulam, flumetsulam, metosulam, bispyribac, pyribenzoxim, pyriftalid, pyrithiobac, pyriminobac-methyl, and salts, esters, acids, or partial acid forms thereof.

7. The composition of claim 1, wherein the acetolactate synthase inhibiting compound is a triazolinone compound.

8. The composition of claim 7, wherein the triazolinone compound is a sulfonylamino carbonyltriazolinone compound.

9. The composition of claim 8, wherein the sulfonylamino carbonyltriazolinone compound has a formula (I): 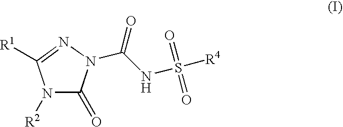
wherein:
R¹ is hydrogen; halogen; C₁₋₆ branched or straight-chain alkyl; C₃₋₆ cycloalkyl; C₂₋₆ alkenyl; C₂₋₆ alkynyl; —O—R³, —S—R³; or oxolan-3-yloxy;
R² is hydrogen; C₁₋₆ branched or straight-chain alkyl; C₃₋₆ cycloalkyl; C₂₋₆ alkenyl;
C₂₋₆ alkynyl; amino, or O—R³;
R³ is C₁₋₆ branched or straight-chain alkyl;
R⁴ is phenyl or thienyl; and
R⁴ optionally is substituted with halogen; C₁₋₆ branched or straight-chain alkyl; C₃₋₆ cycloalkyl; C₂₋₆ alkenyl; C₂₋₆ alkynyl; C₁₋₆ alkoxy optionally substituted with one or more halogen substituents; carboxyl; or carboxyl ester having a formula C(O) —C(O)—O—R⁵, wherein R⁵ is C₁₋₆ branched or straight-chain alkyl.

10. The composition of claim 8, wherein the sulfonylamino carbonyltriazolinone compound has a formula (II): 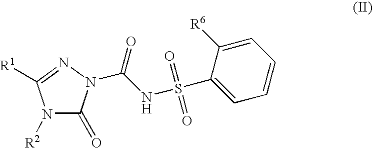
wherein:
R⁶ is hydrogen, halogen; C₁₋₆ branched or straight-chain alkyl; C₃₋₆ cycloalkyl; C₂₋₆ alkenyl; C₂₋₆ alkynyl; C₁₋₆ alkoxy optionally substituted with one or more halogen substituents; carboxyl; or carboxyl ester having a formula —C(O)—O—R⁵, wherein R⁵ is C₁₋₆ alkyl.

11. The composition of claim 8, wherein the sulfonylamino carbonyltriazolinone compound is flucarbazone, propoxycarbazone, or analogs or derivatives thereof that inhibit acetolactate synthase activity.

12. The composition of claim 11, wherein the sulfonylamino carbonyltriazolinone compound is flucarbazone or a salt, ester, acid, or partial acid form thereof.

13. The composition of claim 11, wherein the sulfonylamino carbonyltriazolinone compound is propoxycarbazone or a salt, ester, acid, or partial acid form thereof.

14. The composition of claim 1, wherein the carotenoid-biosynthesis inhibiting compound is classified in Group F2 by Herbicide Resistance Action Committee (HRAC) and Class 28 by the Weed Science of America (WSSA).

15. The composition of claim 1, wherein the carotenoid-biosynthesis inhibiting compound is selected from a group consisting of mesotrione, sulcotrione, tembotrione, isoxachlortole, isoxaflutole, benzofenap, pyrazolynate, pyrazoxyfen, benzobicyclon, and salts, esters, acids, or partial acid forms thereof.

16. The composition of claim 1, wherein the carotenoid-biosynthesis inhibiting compound is a triketone compound.

17. The composition of claim 16, wherein the triketone compound has a formula (IV): 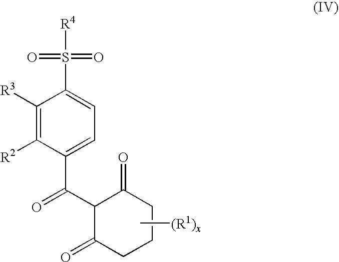
wherein:
R¹ are each independently selected from hydrogen; halogen; C₁₋₆ branched or straight-chain alkyl; C₃₋₆ cycloalkyl; C₂₋₆ alkenyl; C₂₋₆ alkynyl;
x is 0, 1, 2, 3, 4, 5, or 6;
R² is hydrogen; halogen; C₁₋₆ branched or straight-chain alkyl; C₃₋₆ cycloalkyl; C₂₋₆ alkenyl; C₂₋₆ alkynyl, or —N⁺(O)—O⁻;
R³ is hydrogen; halogen; C₁₋₆ branched or straight-chain alkyl; C₃₋₆ cycloalkyl; C₂₋₆ alkenyl; C₂₋₆ alkynyl; or C₁₋₆ alkyl-ether optionally substituted at one or more positions with halogen; and
R⁴ is C₁₋₆ alkyl.

18. The composition of claim 16, wherein the triketone compound is mesotrione, tembotrione, sulcotrione, or analogs or derivatives thereof that inhibit 4-hydroxyphenyl-pyruvate-dioxygenase (4-HPPD) activity.

19. The composition of claim 18, wherein the triketone compound is selected from a group consisting of mesotrione, sulcotrione, and tembotrione.

20. The composition of claim 19, wherein the triketone compound is mesotrione.

21. The composition of claim 19, wherein the triketone compound is sulcotrione.

22. The composition of claim 19, wherein the triketone compound is tembotrione.

23. The composition of claim 1, wherein the carotenoid-biosynthesis inhibiting compound is topramezone.

24. An herbicidal composition comprising:
(a) an herbicidally effective amount of a carotenoid-biosynthesis inhibiting compound or a salt, ester, acid, or partial acid form thereof;
(b) a safening effective amount of an acetolactate synthase inhibiting compound or a salt, ester, acid, or partial acid form thereof, wherein the ratio of (a) to the ratio of (b) is greater than about 2.5:1.

25. The composition of claim 24, wherein the ratio of (a) to the ratio of (b) is greater than about 5:1.

26. The composition of claim 24, wherein the ratio of (a) to the ratio of (b) is greater than about 10:1.

27. A method for selective control of weeds in and around plants, the method comprising applying the composition of claim 1 to the plants, parts of plants, plant seeds, or the area under cultivation.

28. The method of claim 27, wherein the plant is a grass selected from a group consisting of zoysiagrass (Zoysia spp.), bermudagrass (Cynodon spp.), St. Augustine grass (Stenatophrum secundatum), centipede grass (Eremochloa ophiuroides), perennial ryegrass (Lolium perenne), fescue (Festuca/Lolium spp.), bluegrass (Poa spp.), oat (Atena sativa), wheat (Triticum spp.), barley (Hordeum vulgare), rye (Secale cereale), corn (Zea mays), sorghum (Sorghum spp.), and rice (Oryza spp.).

29. A method for selective control of weeds in and around plants, the method comprising applying the composition of claim 24 to the plants, parts of plants, plant seeds, or the area under cultivation.

30. The method of claim 29, wherein the plant is a grass selected from a group consisting of zoysiagrass (Zoysia spp.), bermudagrass (Cynodon spp.), St. Augustine grass (Stenatophrum secundatum), centipede grass (Eremochloa ophiuroides), perennial ryegrass (Lolium perenne), fescue (Festuca/Lolium spp.), bluegrass (Poa spp.), oat (Atena sativa), wheat (Triticum spp.), barley (Hordeum vulgare), rye (Secale cereale), corn (Zea mays), sorghum (Sorghum spp.), and rice (Oryza spp.).

31. A method for selective control of weeds in and around plants, the method comprising:
(a) applying an herbicidally effective amount of one or more carotenoid-biosynthesis inhibiting herbicides to the plants, parts of plants, plant seeds, or area under cultivation, wherein the carotenoid-biosynthesis inhibiting compound is an inhibitor of 4-hydroxyphenyl-pyruvate-dioxygenase (4-HPPD); and
(b) applying a safening effective amount of one or more acetolactate synthase inhibiting compounds or a salt, ester, acid, or partial acid form thereof as a safener to the plants, the parts of plants, the plant seeds, or the area under cultivation before, after, or simultaneously with the application of the herbicide.

32. A method for protecting plants against phytotoxic side-effects of a carotenoid-biosynthesis inhibiting herbicide, the method comprising:
applying a safening effective amount of one or more acetolactate synthase inhibiting compounds or a salt, ester, acid, or partial acid form thereof as a safener to the plants, parts of plants, plant seeds, or the area under cultivation,
wherein the safening effective amount is applied before, after, or simultaneously with the application of an herbicidally effective amount of the herbicide to the plants, parts of plants, plant seeds, or the area under cultivation, and
wherein the carotenoid-biosynthesis inhibiting compound is an inhibitor of 4-hydroxyphenyl-pyruvate-dioxygenase (4-HPPD).

33. A method for selective control of weeds in and around plants, the method comprising:
(a) applying an herbicidally effective amount of one or more carotenoid-biosynthesis inhibiting herbicides to the plants, parts of plants, plant seeds, or area under cultivation; and
(b) applying a safening effective amount of one or more acetolactate synthase inhibiting compounds or a salt, ester, acid, or partial acid form thereof as a safener to the plants, the parts of plants, the plant seeds, or the area under cultivation before, after, or simultaneously with the application of the herbicide, wherein the ratio of the herbicidally effect amount to the safening effective amount is greater than about 2.5:1.

34. A method for protecting plants against phytotoxic side-effects of a carotenoid-biosynthesis inhibiting herbicide, the method comprising:
applying a safening effective amount of one or more acetolactate synthase inhibiting compounds or a salt, ester, acid, or partial acid form thereof as a safener to the plants, parts of plants, plant seeds, or the area under cultivation,
wherein the safening effective amount is applied before, after, or simultaneously with the application of an herbicidally effective amount of the herbicide to the plants, parts of plants, plant seeds, or the area under cultivation, and
wherein the ratio of the herbicidally effect amount to the safening effective amount is greater than about 2.5:1.
